(19) United States
(12) Patent Application Publication
(10) Pub. No.: US 2026/0101908 A1
(43) Pub. Date: Apr. 16, 2026

(54) COMBINATION CANDY AND SPINNER DEVICE

(71) Applicants: Paul A. Roberts, Pompano Beach, FL (US); Michael L. Roberts, Pompano Beach, FL (US)

(72) Inventors: Paul A. Roberts, Pompano Beach, FL (US); Michael L. Roberts, Pompano Beach, FL (US)

(21) Appl. No.: 18/917,307

(22) Filed: Oct. 16, 2024

(51) Int. Cl. A23G 3/56; A63H 13/00; A63H 31/00

(52) U.S. Cl. CPC A23G 3/563; A63H 13/00; A63H 31/00

(57) ABSTRACT

A handheld device, comprising a holder contained in a housing that is configured to receive a piece of candy, wherein the holder includes a gear; a gear assembly contained in the housing that is mechanically coupled to the holder; and a trigger mechanically coupled to the gear assembly, wherein manual actuation of the trigger drives the gear assembly to simultaneously rotate the piece of candy and a spinner.

### BACKGROUND

The disclosed inventive subject matter relates in general to novelty candy items and toys, and more specifically to a manually operated, handheld device that holds a piece of candy and simultaneously rotates a spinner and the piece of candy.

Consumers, regardless of their age, can appreciate entertaining and appealing devices. Novelty candy items and similar toys are one example of such devices that largely appeal to consumers. However, existing novelty candy items and toys include numerous disadvantages, including requiring batteries for operation; providing only minimal entertainment for users; and including aesthetically unappealing designs. Additionally, such devices that are intended for use with candies, such as lollipops and suckers, limit enjoyment to only one side of the candy. Accordingly, there is an ongoing need for a device that simultaneously rotates a spinner and a piece of candy, without the use of batteries. The spinner can advantageously cool the user while providing additional entertainment.

### SUMMARY

The following provides a summary of certain example implementations of the disclosed technology. This summary is not an extensive overview and is not intended to identify key or critical aspects or elements of the disclosed technology or to delineate its scope. However, it is to be understood that the use of indefinite articles in the language used to describe and claim the disclosed technology is not intended in any way to limit the described technology. Rather the use of “a” or “an” should be interpreted to mean “at least one” or “one or more”.

One implementation of the disclosed technology provides a handheld device, comprising a holder contained in a housing that is configured to receive a piece of candy, wherein the holder includes a gear; a gear assembly contained in the housing that is mechanically coupled to the holder; and a trigger mechanically coupled to the gear assembly, wherein manual actuation of the trigger drives the gear assembly to simultaneously rotate the piece of candy and a spinner.

In some implementations, the housing comprises a first casing and a second casing that define an interior cavity; and an upper portion and a lower portion, wherein the piece of candy extends from the upper portion at a predetermined distance above the housing, and wherein the spinner extends from the upper portion at a predetermined distance from the second casing. In various implementations, the piece of candy is substantially perpendicular to the spinner. In some implementations, the gear assembly comprises a drive gear that is meshed with the trigger; a slide gear that is meshed with the drive gear; a first compound gear; and a second compound gear that is meshed with the first compound gear and the gear of the holder, wherein the slide gear engages the first compound gear when the trigger is manually actuated, and wherein the slide gear is separated from the first compound gear when the trigger is static. The second compound gear may be formed on a shaft that is coupled to the spinner. In various implementations, the drive gear comprises a first gear having a first diameter and a predetermined number of teeth; and a second gear having a second diameter and a predetermined number of teeth, wherein the first diameter is smaller than the second diameter, and wherein the predetermined number of teeth of the first gear is less than the predetermined number of teeth of the second gear. In various implementations, the slide gear comprises a first gear having a first diameter and a predetermined number of teeth; and a second gear having a second diameter and a predetermined number of teeth, wherein the first diameter is smaller than the second diameter, and wherein the predetermined number of teeth of the first gear is less than the predetermined number of teeth of the second gear. In various implementations, the first compound gear comprises a first gear having a first diameter and a predetermined number of teeth; a second gear having a second diameter and a predetermined number of teeth; and a third gear that is positioned between the first and second gear, wherein the third gear has a third diameter and a predetermined number of teeth. In some implementations, the first diameter of the first gear of the first compound gear and the second diameter of the second gear of the first compound gear are equal, and wherein the third diameter of the third gear of the first compound gear is greater than the first diameter of the first gear of the first compound gear and the second diameter of the second gear of the first compound gear. In various implementations, the second compound gear comprises a first gear having a first diameter and a predetermined number of teeth; and a second gear that is meshed with the gear of the holder, wherein the second gear has a second diameter and a predetermined number of teeth, wherein the first diameter is smaller than the second diameter, and wherein the predetermined number of teeth of the first gear is less than the predetermined number of teeth of the second gear. In some implementations, the trigger includes a catch having a track of a plurality of teeth. In some implementations, the piece of candy is a lollipop, and wherein the lollipop is substantially rounded or disk-shaped. In some implementations, the housing includes indicia that resembles holiday characters, action figures, celebrities, or animals.

Another implementation of the disclosed technology provides a device that simultaneously rotates a spinner and a piece of candy. The device comprises a housing having a first casing and a second casing that define an interior cavity; a holder having a gear that is contained in the housing, wherein the holder is configured to receive a piece of candy; a trigger having a catch; and a gear assembly contained in the housing, wherein the gear assembly includes a drive gear that is meshed with the catch of the trigger; a slide gear that is meshed with the drive gear; a first compound gear; and a second compound gear that is meshed with the first compound gear and the gear of the holder, wherein manual actuation of the trigger drives the gear assembly to simultaneously rotate the piece of candy and a spinner.

In some implementations, the housing further comprises an upper portion and a lower portion, wherein the piece of candy extends from the upper portion at a predetermined distance above the housing, and wherein the spinner extends from the upper portion at a predetermined distance from the second casing. In various implementations, the second compound gear is formed on a shaft that is coupled to the spinner. In some implementations, the drive gear comprises a first gear; and a second gear, wherein the first gear is centrally formed with the second gear; the slide gear comprises a first gear; and a second gear, wherein the first gear is centrally formed with the second gear; the first compound gear comprises a first gear; a second gear; and a third gear that is positioned between the first and second gear; and the second compound gear comprises a first gear; and a second gear, wherein the first gear is centrally formed with the second gear. In some implementations, the first gear of the drive gear is meshed with the catch of the trigger; the second gear of the drive gear is meshed with the first gear of the slide gear; the second gear of the slide gear engages the first gear of the first compound gear when the trigger is manually actuated; the second gear of the first compound gear is meshed with the second gear of the second compound gear; the third gear of the first compound gear is meshed with the first gear of the second compound gear; and the second gear of the second compound gear is meshed with the gear of the holder. In various implementations, the piece of candy is a lollipop, and wherein the lollipop is substantially rounded or disk-shaped. In various implementations, the housing includes indicia that resembles holiday characters, action figures, celebrities, or animals.

It should be appreciated that all combinations of the foregoing concepts and additional concepts discussed in greater detail below (provided such concepts are not mutually inconsistent) are contemplated as being part of the technology disclosed herein and may be implemented to achieve the benefits as described herein. Additional features and aspects of the disclosed system, devices, and methods will become apparent to those of ordinary skill in the art upon reading and understanding the following detailed description of the example implementations. As will be appreciated by the skilled artisan, further implementations are possible without departing from the scope and spirit of what is disclosed herein. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more example implementations of the disclosed technology and, together with the general description given above and detailed description given below, serve to explain the principles of the disclosed subject matter, and wherein:

FIG. 1 is a front perspective view of an example implementation of the disclosed device in a static position, wherein the device includes a housing having a first casing and a second casing, a piece of candy having a stick, a spinner having one or more blades, and a trigger;

FIG. 2 is a front view of the device of FIG. 1;

FIG. 3 is a first side view of the device of FIG. 1;

FIG. 4 is a second side view of the device of FIG. 1;

FIG. 5 is a rear view of the device of FIG. 1;

FIG. 6 is a top view of the device of FIG. 1;

FIG. 7 is a bottom view of the device of FIG. 1;

FIG. 8 is an interior perspective view of the first casing of the housing of FIG. 1;

FIG. 9 is an interior perspective view of the second casing of the housing of FIG. 1;

FIG. 10 is a front perspective, cross-sectional view of the device of FIG. 1 showing a gear assembly and a holder contained within the housing, wherein the gear assembly includes a drive gear, a slide gear, a first compound gear, and a second compound gear;

FIG. 11 is a rear perspective, cross-sectional view of the device of FIG. 1;

FIG. 12 a first side, cross-sectional view of the device of FIG. 1;

FIG. 13 is a second side, cross-sectional view of the device of FIG. 1;

FIG. 14 is an exploded view of the device of FIG. 1;

FIGS. 15A-15B depict the trigger of FIG. 1, wherein FIG. 15A is a front perspective view of the trigger, and wherein FIG. 15B is a rear perspective view of the trigger;

FIGS. 16A-16B depict the drive gear of FIG. 10, wherein FIG. 16A is a front perspective view of the drive gear, and wherein FIG. 16B is a rear view of the drive gear;

FIGS. 17A-17B depict the slide gear of FIG. 10 formed on a shaft, wherein FIG. 17A is a first side perspective view of the slide gear and shaft, and wherein FIG. 17B is a front view of the slide gear and shaft;

FIGS. 18A-18B depict the first compound gear of FIG. 10 formed on a shaft, wherein FIG. 18A is a front perspective view of the first compound gear and shaft, and wherein FIG. 18B is a rear perspective view of the first compound gear and shaft;

FIGS. 19A-19B depict the second compound gear of FIG. 10 formed on a shaft, wherein FIG. 19A is a second side perspective view of the second compound gear and shaft relative to the spinner, and wherein FIG. 19B is a rear view of the second compound gear and shaft; and

FIG. 20 depicts the holder of FIG. 10 relative to the piece of candy.

### DETAILED DESCRIPTION

Example implementations are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the disclosed technology. Accordingly, the following implementations are set forth without any loss of generality to, and without imposing limitations upon, the claimed subject matter.

The examples discussed herein are examples only and are provided to assist in the explanation of the apparatuses, devices, systems, and methods described herein. None of the features or components shown in the drawings or discussed below should be taken as required for any specific implementation of any of these the apparatuses, devices, systems or methods unless specifically designated as such. For ease of reading and clarity, certain components, modules, or methods may be described solely in connection with a specific Figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Example implementations of the disclosed systems, devices, and methods provide a handheld device that holds a piece of candy, such as a lollipop, sucker, or the like, and that simultaneously rotates a spinner, such as a fan, pinwheel, or the like, and the piece of candy upon manual actuation (e.g. squeezing, compressing, etc.) of a trigger by a user's hand. Rotational speed and duration of the piece of candy and the spinner increase the faster (e.g. more rapidly) the trigger is actuated. The device may be molded, or include various design indicia or elements, to resemble holiday characters (Easter Bunny, Santa Clause, Halloween characters, leprechaun, etc.), action figures, celebrities, or animals.

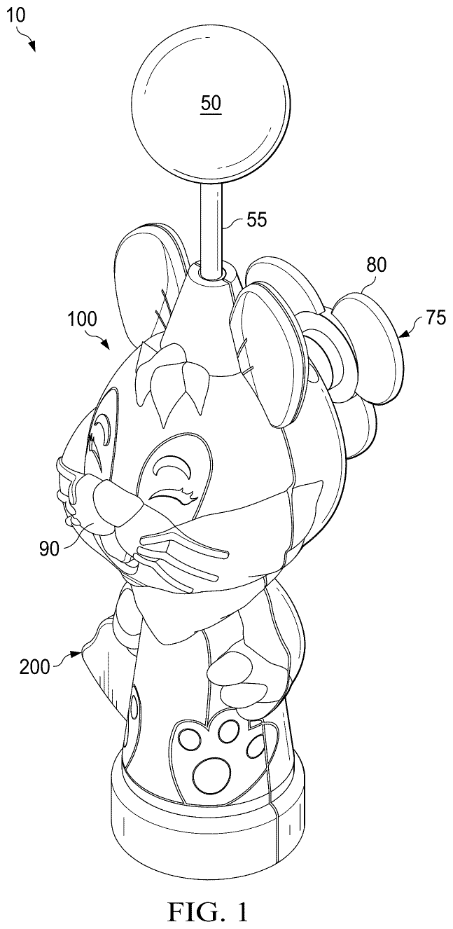

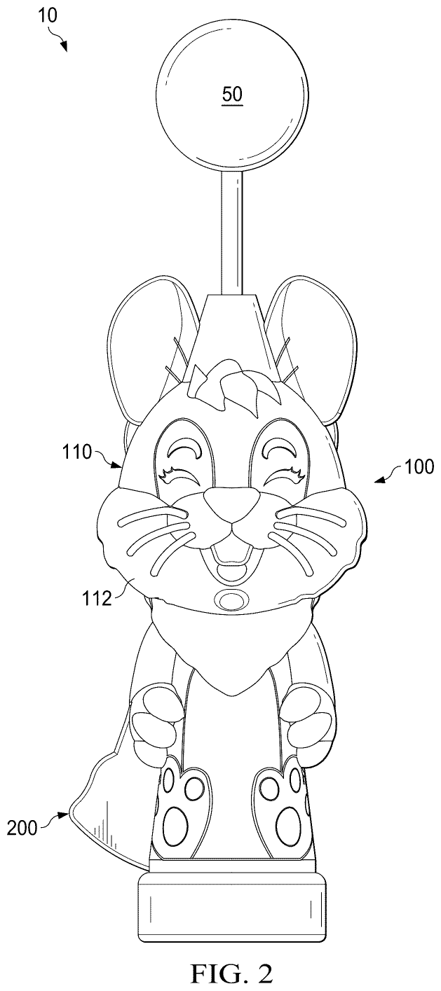

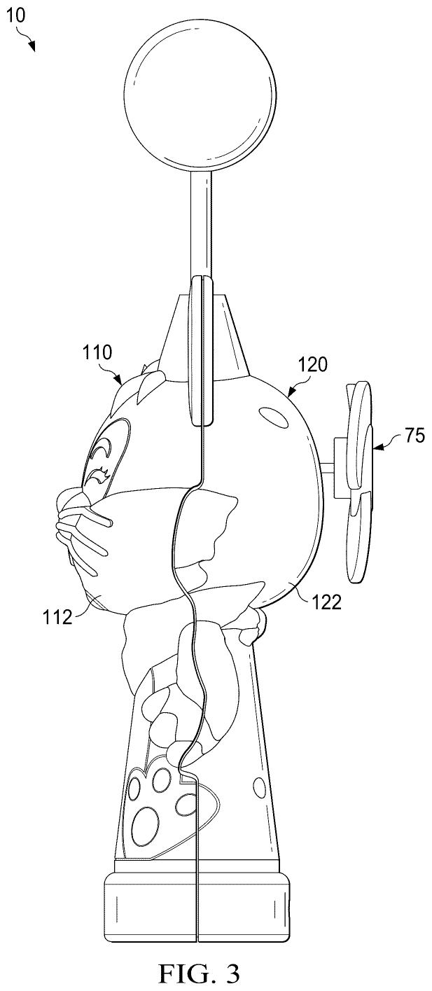

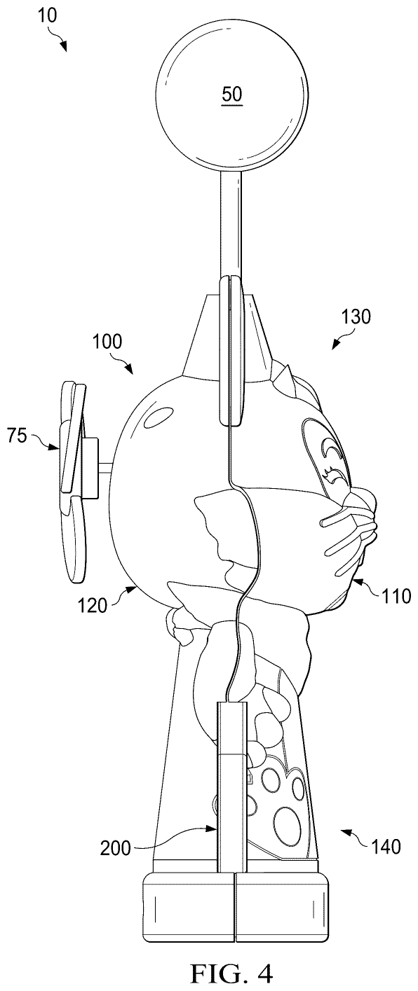

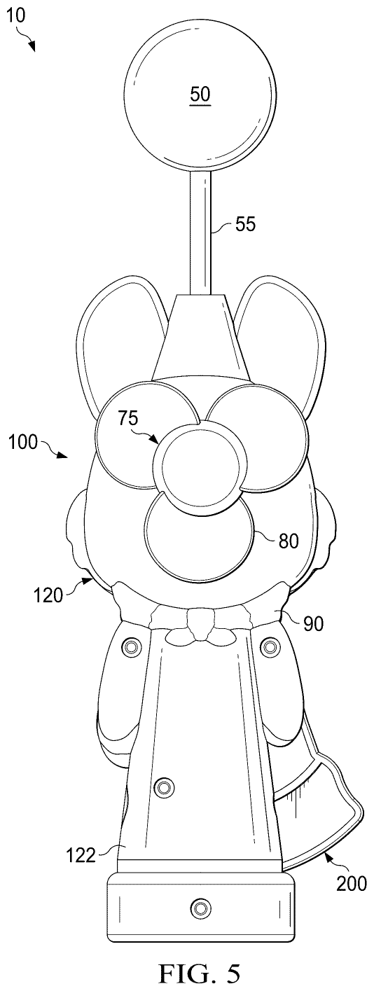

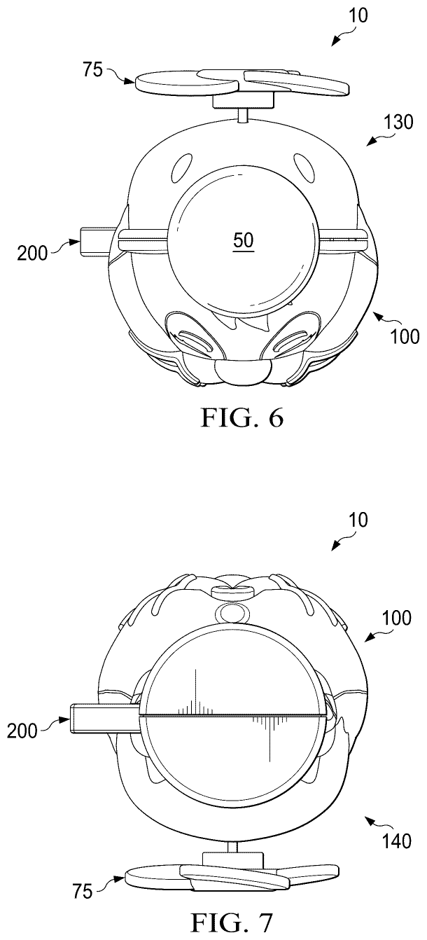

FIG. 1 is a front perspective view of an example implementation of the disclosed device in a static position, wherein the device includes a housing having a first casing and a second casing, a piece of candy having a stick, a spinner having one or more blades, and a trigger; FIG. 2 is a front view of the device of FIG. 1; FIG. 3 is a first side view of the device of FIG. 1; FIG. 4 is a second side view of the device of FIG. 1; FIG. 5 is a rear view of the device of FIG. 1; FIG. 6 is a top view of the device of FIG. 1; and FIG. 7 is a bottom view of the device of FIG. 1.

With specific reference to FIGS. 1-7, device 10 is a handheld device that includes housing 100, piece of candy 50 having stick 55, spinner 75 having blades 80, and trigger 200. Housing 100 is formed from first casing 110 and second casing 120. Housing 100 includes upper portion 130 and lower portion 140. When the device is in a static position (i.e. no rotation of candy 50 or spinner 75), a portion of trigger 200 extends from lower portion 140 of housing 100. Spinner 75 extends outward from second casing 120 in upper portion 130 at a predetermined distance, and candy 50 extends outward from the top of housing 100 in upper portion 130 at a predetermined distance. Piece of candy 50 is substantially perpendicular to spinner 75. First and second casings 110, 120 include indicia 90 that resemble the Easter Bunny, in the present non-limiting embodiment.

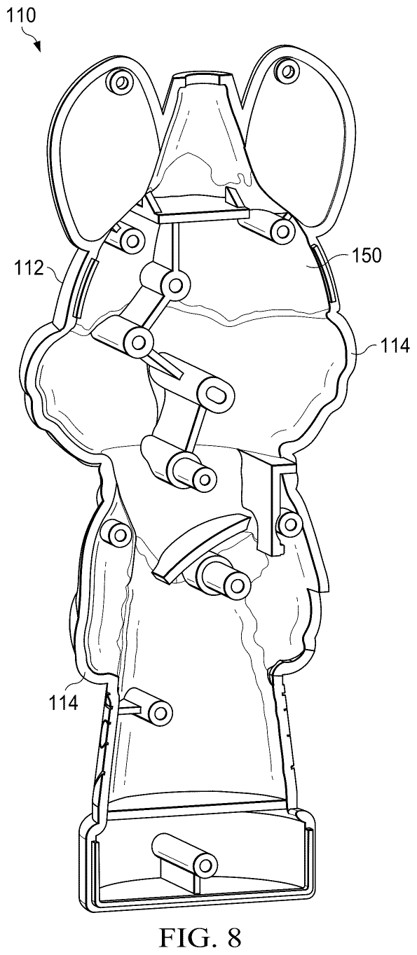

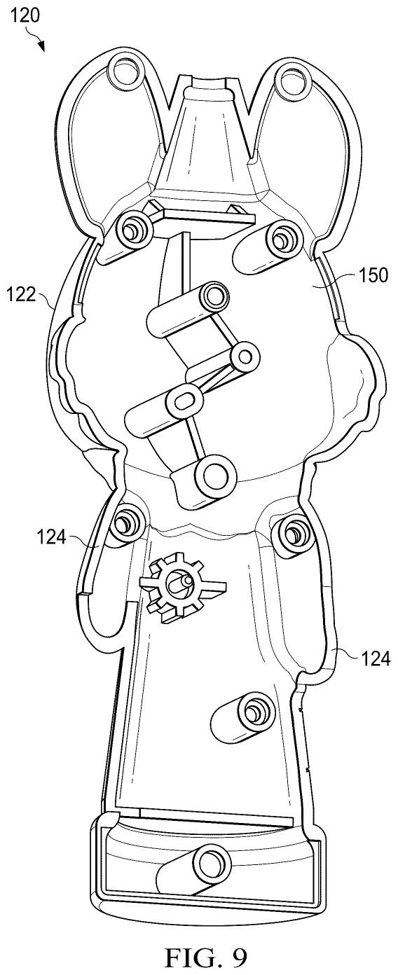

FIG. 8 is an interior perspective view of first casing 110; and FIG. 9 is an interior perspective view of second casing 120. With reference to FIGS. 1-9, first casing 110 includes exterior surface 112 and interior surface 114. Second casing 120 includes exterior surface 122 and interior surface 124. Interior surface 114 and interior surface 124 mate to form housing 100, to define internal cavity 150 within housing 100, and to secure the internal components within internal cavity 150.

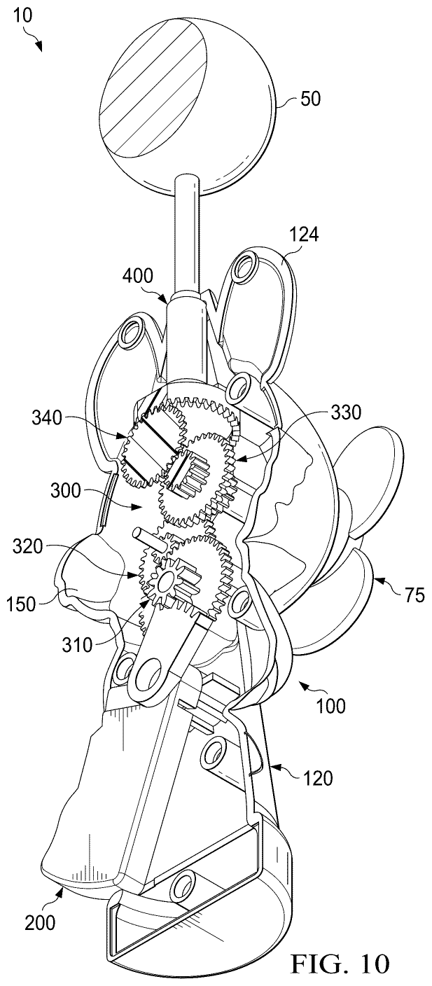

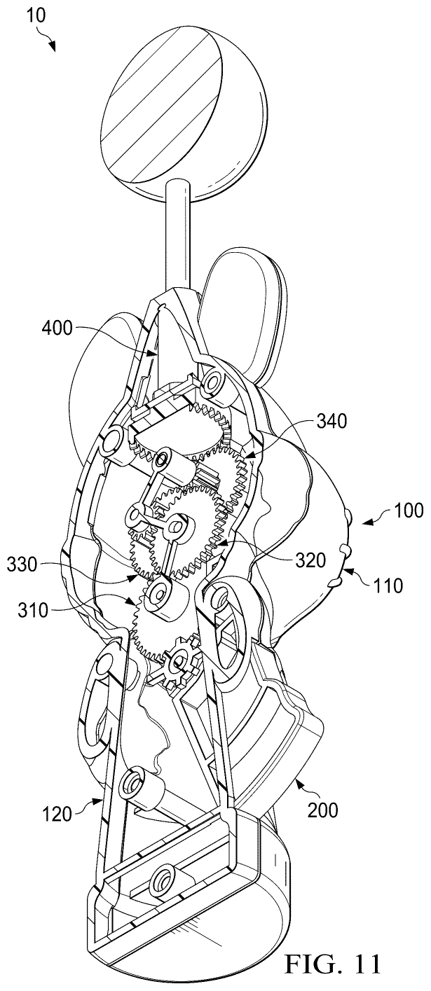

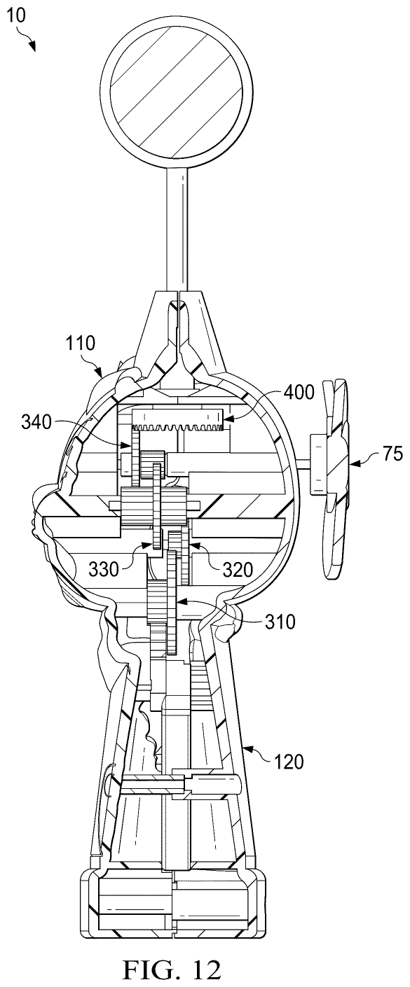

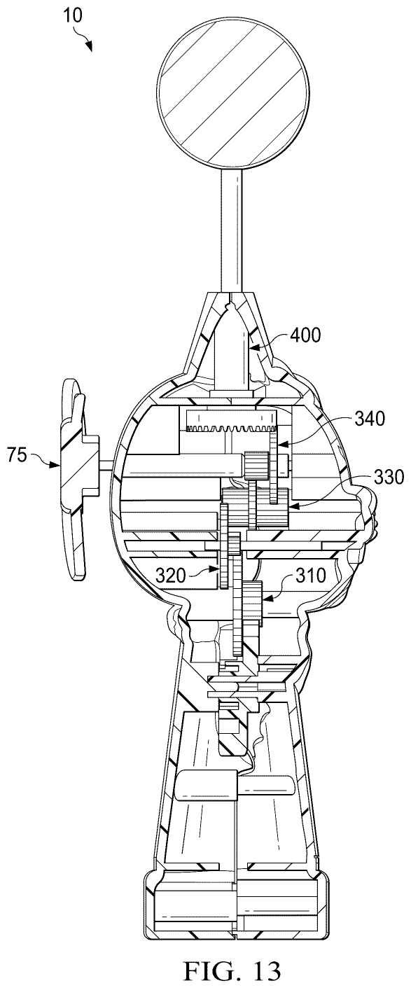

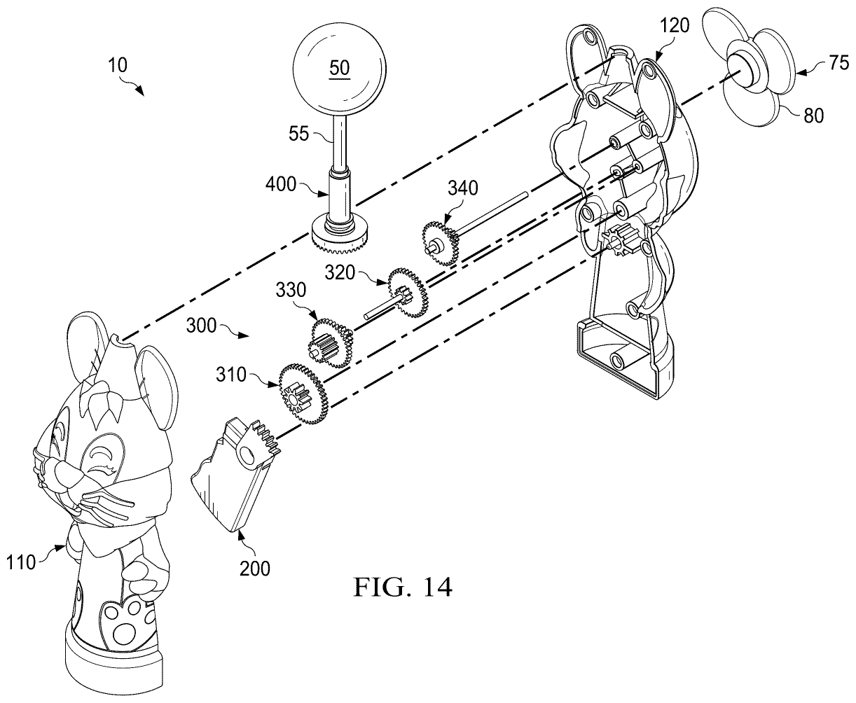

FIG. 10 is a front perspective, cross-sectional view of device 10 showing a gear assembly contained within housing 100; FIG. 11 is a rear perspective, cross-sectional view of device 10; FIG. 12 a first side, cross-sectional view of device 10; FIG. 13 is a second side, cross-sectional view of device 10; and FIG. 14 is an exploded view of device 10. With reference to FIGS. 10-14, housing 100 contains gear assembly 300 and holder 400 positioned within internal cavity 150, wherein gear assembly 300 includes drive gear 310, slide gear 320, a first compound gear 330, and a second compound gear 340.

FIGS. 15A-15B depict trigger 200, wherein FIG. 15A is a front perspective view of trigger 200, and wherein FIG. 15B is a rear perspective view of trigger 200. With reference to FIGS. 10-14 and 15A-15B, trigger 200 includes body 210 and catch 220 coupled to body 210. Catch 220 includes a track 230 having a plurality of teeth 232. Trigger 200 is pivotally coupled to housing 100 in internal cavity 150 between first and second casings 110, 120.

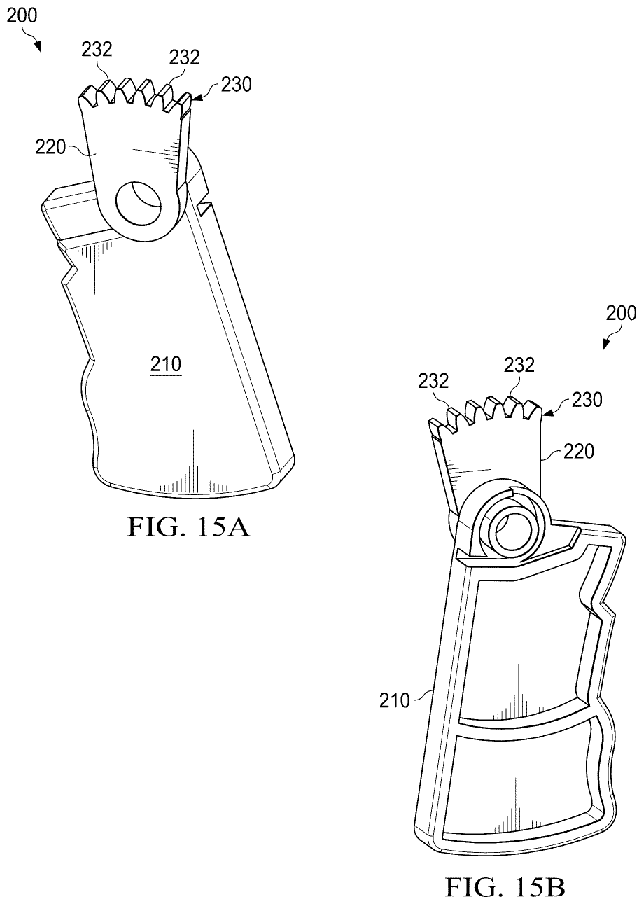

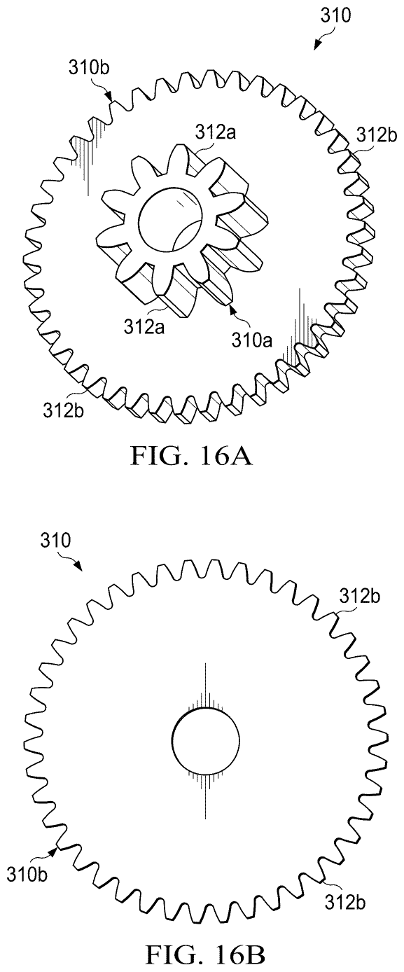

FIGS. 16A-16B depict drive gear 310, wherein FIG. 16A is a front perspective view of drive gear 310, and wherein FIG. 16B is a rear view of drive gear 310. With reference to FIGS. 10-14 and 16A-16B, drive gear 310 includes first gear 310a that is integrally and centrally formed with second gear 310b. First gear 310a and second gear 310b are configured to rotate simultaneously when driven. First gear 310a includes a predetermined number of teeth 312a, and second gear 310b includes a predetermined number of teeth 312b, wherein second gear 310b includes a greater number of teeth 312b than teeth 312a of first gear 310a.

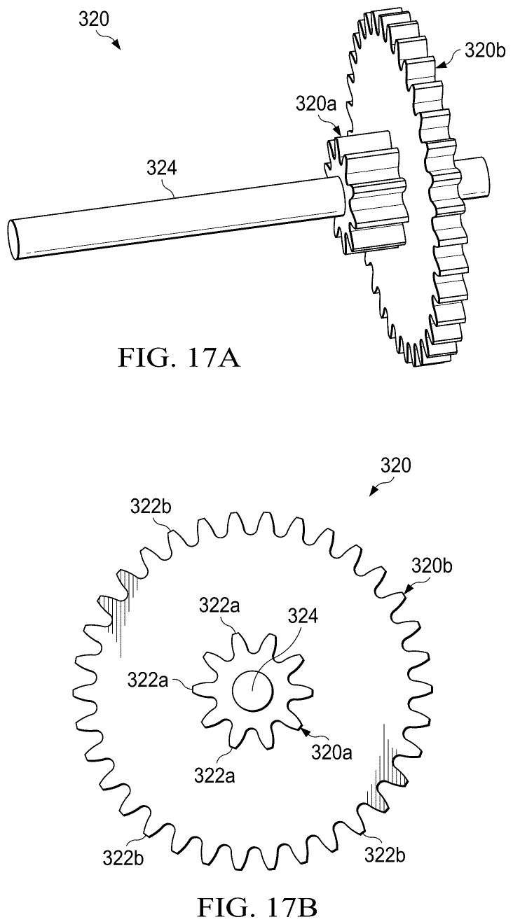

FIGS. 17A-17B depict slide gear 320 formed on a shaft, wherein FIG. 17A is a first side perspective view of slide gear 320 and the shaft, and wherein FIG. 17B is a front view of slide gear 320 and shaft. With reference to FIGS. 10-14 and 17A-17B, slide gear 320 is formed on shaft 324. Slide gear 320 includes first gear 320a that is integrally and centrally formed with second gear 320b. First gear 320a includes a predetermined number of teeth 322a, and second gear 320b includes a predetermined number of teeth 322b, wherein second gear 320b includes a greater number of teeth 322b than teeth 322a of first gear 320a.

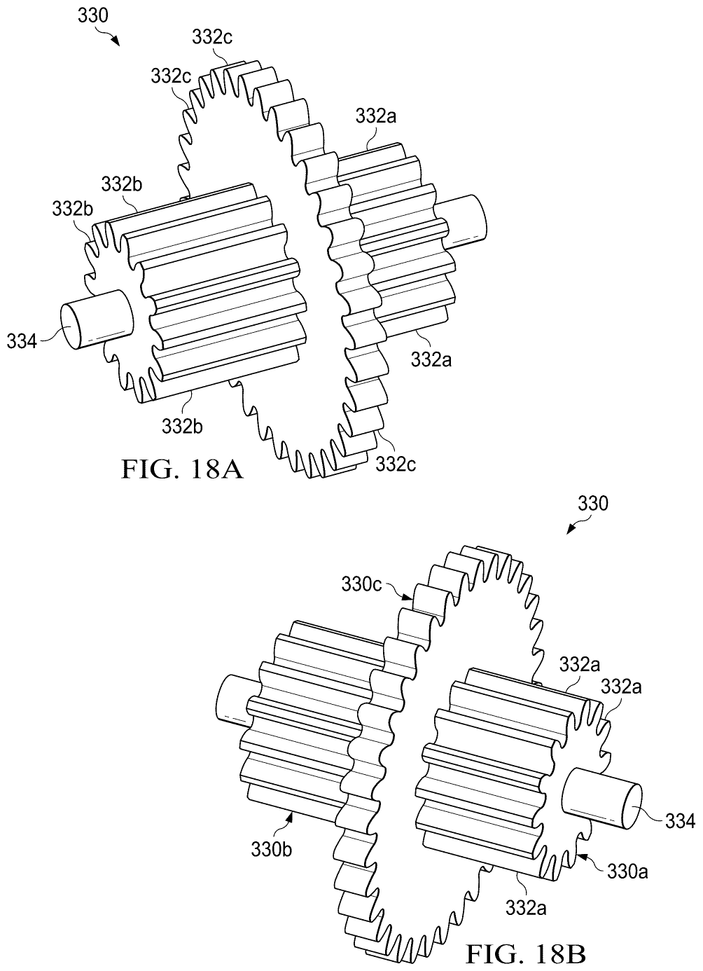

FIGS. 18A-18B depict first compound gear 330 formed on a shaft, wherein FIG. 18A is a front perspective view of first compound gear 330 and the shaft, and wherein FIG. 18B is a rear perspective view of first compound gear 330 and the shaft. With reference to FIGS. 10-14 and 18A-18B, first compound gear 330 is formed on shaft 334. First compound gear 330 includes first gear 330a having a predetermined number of teeth 332a, a second gear 330b having a predetermined number of teeth 332b, and a third gear 330c having a predetermined number of teeth 332c. First gear 330a and second gear 330b are integrally and centrally formed with third gear 330c. First gear 330a, second gear 330b, and third gear 330c are configured to rotate simultaneously when driven. First gear 330a and second gear 330b include the same number of teeth 332a, 332b. Third gear 330c includes a greater number of teeth 332c that teeth 332a, 332b of first gear 320a and second gear 320b, respectively.

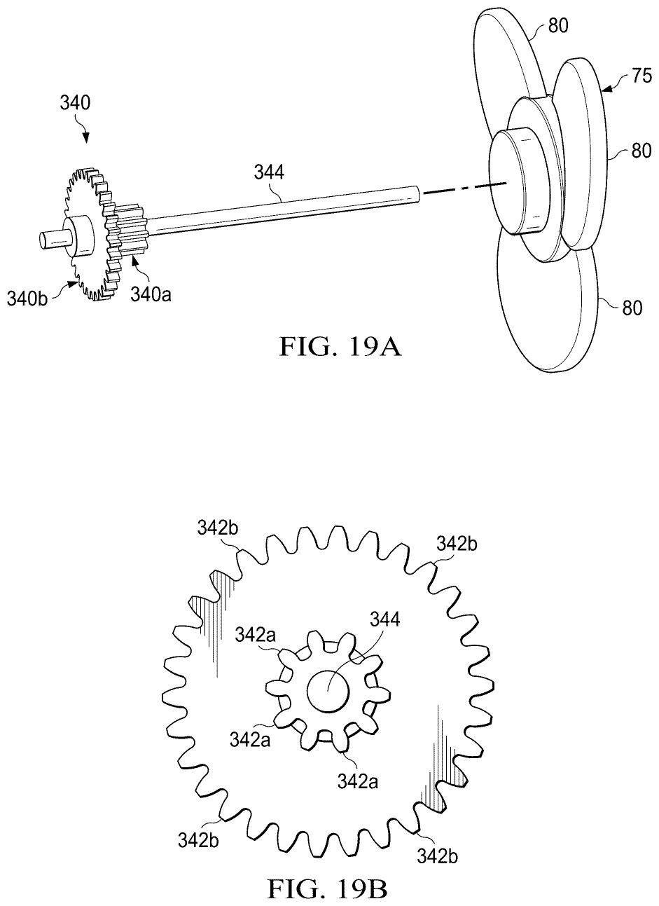

FIGS. 19A-19B depict second compound gear 340 formed on a shaft, wherein FIG. 19A is a second side perspective view of second compound gear 340 and the shaft relative to spinner 75, and wherein FIG. 19B is a rear view of second compound gear 340 and the shaft. With reference to FIGS. 10-14 and 19A-19B, second compound gear 340 is formed on shaft 344, wherein shaft 344 is configured to rotate spinner 75. Second compound gear 340 includes first gear 340a that is integrally and centrally formed with second gear 340b. First gear 340a, second gear 340b, and shaft 344 are configured to rotate simultaneously when driven. First gear 340a includes a predetermined number of teeth 342a, and second gear 340b includes a predetermined number of teeth 342b, wherein second gear 340b includes a greater number of teeth 342b than teeth 342a of first gear 340a.

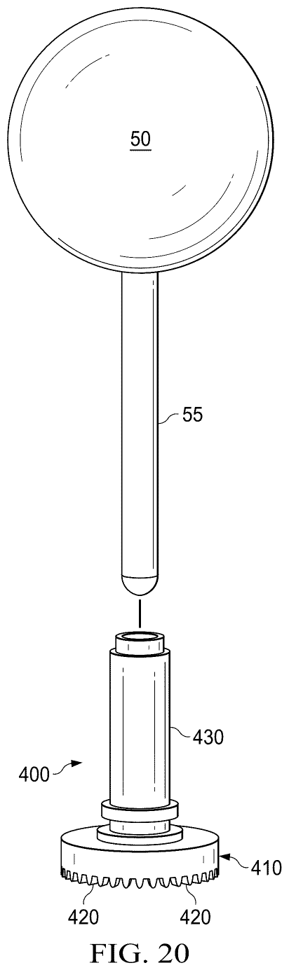

FIG. 20 depicts holder 400 that is configured to hold and rotate piece of candy 50. With reference to FIGS. 10-14 and 20, holder 400 includes gear 410 having a predetermined number of teeth 420, and receiving portion 430 that is configured to hold stick 55 of piece of candy 50. Rotation of gear 410 correspondingly rotates receiving portion 420 and piece of candy 50.

Now referring to FIGS. 10-20, within internal cavity 150 of housing 100, gear 410 is substantially perpendicular to drive gear 310, slide gear 320, first compound gear 330, and second compound gear 340. Prior to manually actuating trigger 200: (i) a portion of track 230 on catch 220 is meshed with first gear 310a of drive gear 310; (ii) second gear 310b of drive gear 310 is meshed with first gear 320a of slide gear 320; (iii) second gear 320b of slide gear 320 is separated from (i.e. not meshed with) first compound gear 330; (iv) second gear 330b and third gear 330c of first compound gear 330 are meshed with second gear 340b and first gear 340a of second compound gear 340, respectively; and (v) second gear 340b is meshed with gear 410 of holder 400.

Still referring to FIGS. 10-20, when manually actuated, trigger 200 pivots within housing 100, causing track 230 to move over first gear 310a and rotate first and second gears 310a, 310b of drive gear 310. Rotation of second gear 310b causes first gear 320a of slide gear 320 to rotate and slide into engagement with first gear 330a of compound gear 330, thereby rotating first, second, and third gears 330a, 330b, 330c of compound gear 330. After engaging first gear 330a, slide gear 320 returns to its non-meshed, separated position. Rotation of second and third gears 330b, 330c causes second and first gears 340b, 340a of second compound gear 340 to rotate, respectively. Rotation of second compound gear 340 correspondingly rotates shaft 344 coupled to spinner 75. Rotation of second gear 340b causes gear 410 to rotate, which correspondingly rotates receiving portion 420 that holds piece of candy 50. Manual actuation of trigger 200 simultaneously rotates piece of candy 50 held in holder 400 and spinner 75. Manual actuation of trigger 200 can be repeated numerous times and at numerous frequencies in order to increase or decrease the rate and duration at which the candy 50 and spinner 75 rotate.

In non-limiting examples, the piece of candy used with the disclosed device is substantially round. In other non-limiting examples, the piece of candy used with the disclosed device is disk-shaped.

All literature and similar material cited in this application, including, but not limited to, patents, patent applications, articles, books, treatises, and web pages, regardless of the format of such literature and similar materials, are expressly incorporated by reference in their entirety. Should one or more of the incorporated references and similar materials differs from or contradicts this application, including but not limited to defined terms, term usage, described techniques, or the like, this application controls.

As previously stated and as used herein, the singular forms “a,” “an,” and “the,” refer to both the singular as well as plural, unless the context clearly indicates otherwise. The term “comprising” as used herein is synonymous with “including,” “containing,” or “characterized by,” and is inclusive or open-ended and does not exclude additional, unrecited elements or method steps. Although many methods and materials similar or equivalent to those described herein can be used, particular suitable methods and materials are described herein. Unless context indicates otherwise, the recitations of numerical ranges by endpoints include all numbers subsumed within that range. Furthermore, references to “one implementation” are not intended to be interpreted as excluding the existence of additional implementations that also incorporate the recited features. Moreover, unless explicitly stated to the contrary, implementations “comprising” or “having” an element or a plurality of elements having a particular property may include additional elements whether or not they have that property.

The terms “substantially” and “about”, if or when used throughout this specification describe and account for small fluctuations, such as due to variations in processing. For example, these terms can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%, and/or 0%.

Underlined and/or italicized headings and subheadings are used for convenience only, do not limit the disclosed subject matter, and are not referred to in connection with the interpretation of the description of the disclosed subject matter. All structural and functional equivalents to the elements of the various implementations described throughout this disclosure that are known or later come to be known to those of ordinary skill in the art are expressly incorporated herein by reference and intended to be encompassed by the disclosed subject matter. Moreover, nothing disclosed herein is intended to be dedicated to the public regardless of whether such disclosure is explicitly recited in the above description.

There may be many alternate ways to implement the disclosed technology. Various functions and elements described herein may be partitioned differently from those shown without departing from the scope of the disclosed technology. Generic principles defined herein may be applied to other implementations. Different numbers of a given module or unit may be employed, a different type or types of a given module or unit may be employed, a given module or unit may be added, or a given module or unit may be omitted.

Regarding this disclosure, the term “a plurality of” refers to two or more than two. Unless otherwise clearly defined, orientation or positional relations indicated by terms such as “upper” and “lower” are based on the orientation or positional relations as shown in the FIGS., only for facilitating description of the disclosed technology and simplifying the description, rather than indicating or implying that the referred devices or elements must be in a particular orientation or constructed or operated in the particular orientation, and therefore they should not be construed as limiting the disclosed technology. The terms “connected”, “mounted”, “fixed”, etc. should be understood in a broad sense. For example, “connected” may be a fixed connection, a detachable connection, or an integral connection; a direct connection, or an indirect connection through an intermediate medium. For an ordinary skilled in the art, the specific meaning of the above terms in the disclosed technology may be understood according to specific circumstances.

It should be appreciated that all combinations of the foregoing concepts and additional concepts discussed in greater detail herein (provided such concepts are not mutually inconsistent) are contemplated as being part of the disclosed technology. In particular, all combinations of claimed subject matter appearing at the end of this disclosure are contemplated as being part of the technology disclosed herein. While the disclosed technology has been illustrated by the description of example implementations, and while the example implementations have been described in certain detail, there is no intention to restrict or in any way limit the scope of the appended claims to such detail. Additional advantages and modifications will readily appear to those skilled in the art. Therefore, the disclosed technology in its broader aspects is not limited to any of the specific details, representative devices and methods, and/or illustrative examples shown and described. Accordingly, departures may be made from such details without departing from the spirit or scope of the general inventive concept.

What is claimed:

1. A handheld device, comprising:
(a) a holder contained in a housing that is configured to receive a piece of candy, wherein the holder includes a gear;
(b) a gear assembly contained in the housing that is mechanically coupled to the holder; and
(c) a trigger mechanically coupled to the gear assembly, wherein manual actuation of the trigger drives the gear assembly to simultaneously rotate the piece of candy and a spinner.

2. The handheld device of claim 1, wherein the housing comprises:
(a) a first casing and a second casing that define an interior cavity; and
(b) an upper portion and a lower portion,
wherein the piece of candy extends from the upper portion at a predetermined distance above the housing, and
wherein the spinner extends from the upper portion at a predetermined distance from the second casing.

3. The handheld device of claim 2, wherein the piece of candy is substantially perpendicular to the spinner.

4. The handheld device of claim 1, wherein the gear assembly comprises:
(a) a drive gear that is meshed with the trigger;
(b) a slide gear that is meshed with the drive gear;
(c) a first compound gear; and
(d) a second compound gear that is meshed with the first compound gear and the gear of the holder,
wherein the slide gear engages the first compound gear when the trigger is manually actuated, and wherein the slide gear is separated from the first compound gear when the trigger is static.

5. The handheld device of claim 4, wherein the second compound gear is formed on a shaft that is coupled to the spinner.

6. The handheld device of claim 4, wherein the drive gear comprises:
(a) a first gear having a first diameter and a predetermined number of teeth; and
(b) a second gear having a second diameter and a predetermined number of teeth,
wherein the first diameter is smaller than the second diameter, and wherein the predetermined number of teeth of the first gear is less than the predetermined number of teeth of the second gear.

7. The handheld device of claim 4, wherein the slide gear comprises:
(a) a first gear having a first diameter and a predetermined number of teeth; and
(b) a second gear having a second diameter and a predetermined number of teeth,
wherein the first diameter is smaller than the second diameter, and wherein the predetermined number of teeth of the first gear is less than the predetermined number of teeth of the second gear.

8. The handheld device of claim 4, wherein the first compound gear comprises:
(a) a first gear having a first diameter and a predetermined number of teeth;
(b) a second gear having a second diameter and a predetermined number of teeth; and
(c) a third gear that is positioned between the first and second gear, wherein the third gear has a third diameter and a predetermined number of teeth.

9. The handheld device of claim 8, wherein the first diameter and the second diameter are equal, and wherein the third diameter is greater than the first and second diameters.

10. The handheld device of claim 4, wherein the second compound gear comprises:
(a) a first gear having a first diameter and a predetermined number of teeth; and
(b) a second gear that is meshed with the gear of the holder, wherein the second gear has a second diameter and a predetermined number of teeth,
wherein the first diameter is smaller than the second diameter, and wherein the predetermined number of teeth of the first gear is less than the predetermined number of teeth of the second gear.

11. The handheld device of claim 1, wherein the trigger includes a catch having a track of a plurality of teeth.

12. The handheld device of claim 1, wherein the piece of candy is a lollipop, and wherein the lollipop is substantially rounded or disk-shaped.

13. The handheld device of claim 1, wherein the housing includes indicia that resembles holiday characters, action figures, celebrities, or animals.

14. A device that simultaneously rotates a spinner and a piece of candy, comprising:
(a) a housing having a first casing and a second casing that define an interior cavity;
(b) a holder having a gear that is contained in the housing, wherein the holder is configured to receive a piece of candy;
(c) a trigger having a catch; and
(d) a gear assembly contained in the housing, wherein the gear assembly includes:
(i) a drive gear that is meshed with the catch of the trigger;
(ii) a slide gear that is meshed with the drive gear;
(iii) a first compound gear; and
(iv) a second compound gear that is meshed with the first compound gear and the gear of the holder,
wherein manual actuation of the trigger drives the gear assembly to simultaneously rotate the piece of candy and a spinner.

15. The device of claim 14, wherein the housing further comprises an upper portion and a lower portion, wherein the piece of candy extends from the upper portion at a predetermined distance above the housing, and wherein the spinner extends from the upper portion at a predetermined distance from the second casing.

16. The device of claim 14, wherein the second compound gear is formed on a shaft that is coupled to the spinner.

17. The device of claim 14, wherein:
(a) the drive gear comprises:
(i) a first gear; and
(ii) a second gear, wherein the first gear is centrally formed with the second gear;
(b) the slide gear comprises:
(i) a first gear; and
(ii) a second gear, wherein the first gear is centrally formed with the second gear;
(c) the first compound gear comprises:
(i) a first gear;
(ii) a second gear; and
(iii) a third gear that is positioned between the first and second gear; and
(d) the second compound gear comprises:
(i) a first gear; and
(ii) a second gear, wherein the first gear is centrally formed with the second gear.

18. The device of claim 17, wherein:
(a) the first gear of the drive gear is meshed with the catch of the trigger;
(b) the second gear of the drive gear is meshed with the first gear of the slide gear;
(c) the second gear of the slide gear engages the first gear of the first compound gear when the trigger is manually actuated;
(d) the second gear of the first compound gear is meshed with the second gear of the second compound gear;
(e) the third gear of the first compound gear is meshed with the first gear of the second compound gear; and
(f) the second gear of the second compound gear is meshed with the gear of the holder.

19. The device of claim 14, wherein the piece of candy is a lollipop, and wherein the lollipoi sp substantially rounded or disk-shaped.

20. The device of claim 14, wherein the housing includes indicia that resembles holiday characters, action figures, celebrities, or animals.
